(19) United States
(12) Patent Application Publication
(10) Pub. No.: US 2020/0264634 A1
(43) Pub. Date: Aug. 20, 2020

(54) AUTONOMOUS VEHICLE PLATOONING SYSTEM AND METHOD

(71) Applicant: DRiV Automotive Inc., Lake Forest, IL (US)

(72) Inventors: Rod HADI, Grass Lake, MI (US); Michael A. GOLIN, Grass Lake, MI (US)

(73) Assignee: DRiV Automotive Inc., Lake Forest, IL (US)

(21) Appl. No.: 16/793,785

(22) Filed: Feb. 18, 2020

Related U.S. Application Data
(60) Provisional application No. 62/806,120, filed on Feb. 15, 2019.

(51) Int. Cl. G05D 1/02; B60W 60/00

(52) U.S. Cl. CPC G05D 1/0295; B60W 60/005; B60W 60/0023

(57) ABSTRACT

A method for implementing vehicle platooning includes: linking, by a handoff control module, a plurality of vehicles to form a platoon; selectively assigning, by the handoff control module, a first vehicle of the plurality of vehicles as a lead vehicle and remaining ones of the plurality of vehicles as lag vehicles, wherein at least one driving function of the lag vehicles is controlled in accordance with the lead vehicle; determining, by the handoff control module, a first lead vehicle interval for the first vehicle as the lead vehicle; and in response to the first lead vehicle interval expiring, selectively assigning, by the handoff control module, the first vehicle as a lag vehicle and a second vehicle of the plurality of vehicles as the lead vehicle for a second lead vehicle interval.

### CROSS-REFERENCE TO RELATED APPLICATION

This application claims the benefit of U.S. Provisional Application No. 62/806,120, filed Feb. 15, 2019, titled “Autonomous Vehicle Platooning System,” the content of which is incorporate herein by reference in its entirety.

### FIELD

The present disclosure relates to platooning control systems and methods for autonomous and semi-autonomous vehicles.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Vehicles (including semi-trailer trucks and other long-haul vehicles) may have autonomous or semi-autonomous driving capabilities. For example, an autonomous vehicle may include one or more sensors such as cameras, laser sensors, radar sensors, etc. The sensors are arranged to sense objects such as other vehicles, road infrastructure and/or road hazards, lane markings, traffic signs and lights, etc. The autonomous vehicle is configured to travel on roadways in accordance with data collected via the sensors and/or additional data including, but not limited to, data from a global positioning system, driver inputs, data received from other vehicles, etc.

Despite the autonomous or semi-autonomous driving capabilities of the vehicles, drivers of some vehicles, particularly trucks, still need to sit behind the wheel to handle unexpected situations. Driver fatigue has been a concern in highway safety. Moreover, commercial vehicles such as semi-trailer trucks have relatively large fuel tanks (e.g., 100-150 gallons), refueling and driver downtime significantly increase travel time, and batteries of electric and hybrid electric vehicles must be recharged periodically.

The above-mentioned issues are addressed in the present disclosure.

### SUMMARY

In one form, a method of implementing vehicle platooning is provided. The method includes: linking, by a handoff control module, a plurality of vehicles to form a platoon; selectively assigning, by a handoff control module, a first vehicle of the plurality of vehicles as a lead vehicle and remaining ones of the plurality of vehicles as lag vehicles, wherein at least one driving function of the lag vehicles is controlled by the lead vehicle; determining, by the handoff control module, a first lead vehicle interval for the first vehicle as the lead vehicle; and in response to the first lead vehicle interval expiring, selectively assigning, by the handoff control module, the first vehicle as a lag vehicle and a second vehicle of the plurality of vehicles as the lead vehicle for a second lead vehicle interval.

In other features, the at least one driving function of the lag vehicles controlled by the lead vehicle includes at least one of vehicle speed, steering, and braking. The first lead vehicle interval may be determined based on a default interval. The method further comprises: receiving, by the handoff control module and from the plurality of vehicles, at least one desired duration for the first lead vehicle interval and selectively selecting the first lead vehicle, by the handoff control module, the first lead vehicle interval based on the at least one request; and initializing a timer when the first lead vehicle is selected, wherein when the timer reaches a predetermined threshold, the handoff control module selects the second lead vehicle.

In still other features, the method further comprises: transmitting, by the handoff control module, information about the assigned lead and lag vehicles and the first and second lead vehicle intervals to the plurality of vehicles; and displaying the information on a display device in each of the vehicles in the platoon. The information may include at least one of a remaining duration of the first lead vehicle interval, an indication that the first lead vehicle interval has expired, and an indication of a next lead vehicle to be assigned in the second lead vehicle interval.

In still other features, the method further comprises: receiving, by the handoff control module and from the plurality of vehicles, at least one request to adjust the first lead vehicle interval and selectively adjusting, by the handoff control module, the first lead vehicle interval based on the at least one request before the first lead vehicle interval expires. The at least one request is made by using a cellular phone, a short wave radio, or a satellite radio. The handoff control module may be integrated in an electronic device selected from a group consisting of a smartphone, a tablet computer, a navigation system, and a remote server.

In still other features, the method further comprises: selectively repositioning, by an autonomous vehicle control module, a respective one of the plurality of vehicles as the lead vehicle or one of the lag vehicles in response to the information; receiving, by the handoff control module, a request from an unlinked vehicle and re-arranging a sequence of the vehicles in the platoon in response to the request; and receiving, by the handoff control module, a request from an unlinked vehicle and adjusting the first lead vehicle interval in response to the request; and operating the lag vehicles by a semi-autonomous control module or an autonomous control module of the lag vehicles and by a driver of the lead vehicle.

In another form, a system including a handoff control module is provided. The handoff control module is configured to communicate with a plurality of vehicles linked together in a platoon, selectively assign, for a first lead vehicle interval, a first vehicle of the plurality of vehicles as a lead vehicle and remaining ones of the plurality of vehicles as lag vehicles, wherein at least one driving function of the lag vehicles is controlled in accordance with the lead vehicle, and in response to the first lead vehicle interval expiring, selectively assign the first vehicle as a lag vehicle and a second vehicle of the plurality of vehicles as the lead vehicle for a second lead vehicle interval. The handoff control module includes a communication interface that is configured to transmit information about the assigned lead and lag vehicles and the first and second lead vehicle intervals to the plurality of vehicles.

In other features, the handoff control module is disposed in more than one the plurality of vehicles in the platoon and only the handoff control module in the lead vehicle performs the assigning of the plurality of vehicles as the lead and lag vehicles.

### DRAWINGS

The present disclosure will become more fully understood from the detailed description and the accompanying drawings, wherein:

FIG. 1 is a functional block diagram of an autonomous or semi-autonomous vehicle that is in communication with a handoff control module of a vehicle platooning system constructed in accordance with the teachings of the present disclosure;

FIG. 2 is a functional block diagram of an example vehicle platooning system constructed in accordance with the teachings of the present disclosure; and

FIG. 3 is a flow chart of a method of implementing vehicle platooning in accordance with the teachings of the present disclosure.

In the drawings, reference numbers may be reused to identify similar and/or identical elements.

### DETAILED DESCRIPTION

The following description is merely exemplary in nature and is not intended to limit the present disclosure, application, or uses. It should be understood that throughout the drawings, corresponding reference numerals indicate like or corresponding parts and features.

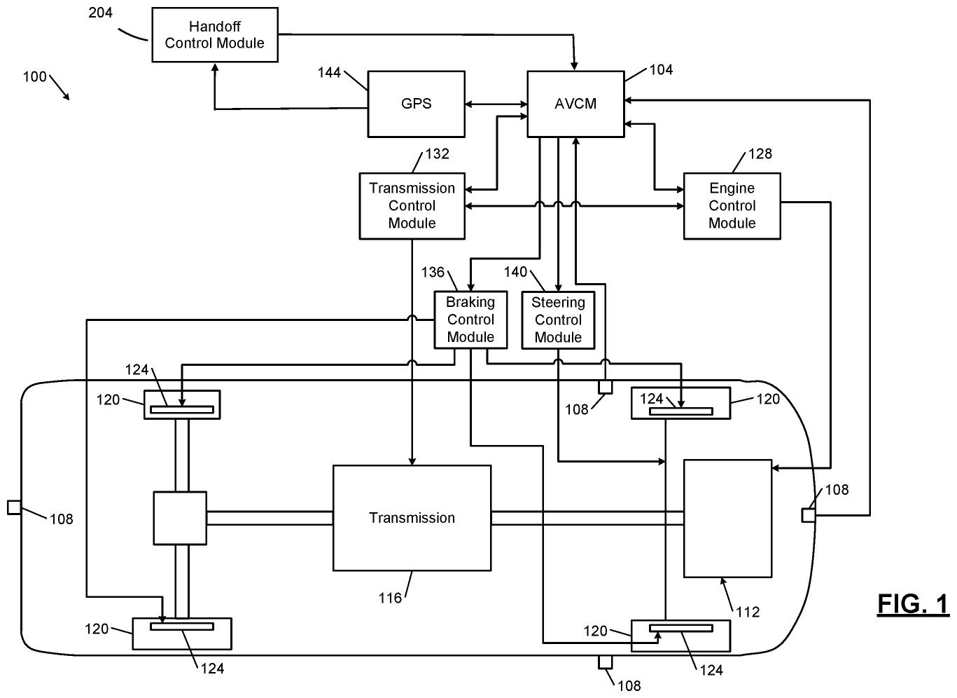

Referring now to FIG. 1, an example vehicle 100 having autonomous driving capabilities is shown. For example, the vehicle 100 includes an autonomous vehicle control module (AVCM) 104 configured to control one or more vehicle functions including, but not limited to, braking, steering, acceleration, transmission (i.e., gear shifting), etc. in accordance with signals received from one or more sensing devices, such as cameras, proximity sensors, lasers, etc. For simplicity, the sensing devices as described herein correspond to cameras such as cameras 108 arranged on a front, sides, rear, etc. of a vehicle to detect objects (e.g., other vehicles). The cameras 108 generate images of the environment in the front, rear, and to the sides of the vehicle 100. For example, the vehicle 100 includes systems including, but not limited to, an engine 112, transmission 116, wheels 120, and brakes 124. In some examples, the vehicle 100 may be an electric or hybrid electric vehicle including a motor (not shown), and the engine 112 may be omitted.

The AVCM 104 may selectively control systems of the vehicle 100 via respective control modules, including, but not limited to, an engine control module 128, a transmission control module 132, a braking control module 136, and a steering control module 140. In some examples, the vehicle 100 includes a global positioning system (GPS) 144 or other type of global navigation satellite system (GNSS) to determine a location of the vehicle 100. The AVCM 104 is configured to provide autonomous control of the vehicle 100 based on vehicle location data received from the GPS 144 in addition to signals received from the cameras 108, and driver inputs. The AVCM 104 also communicates with and receives signals from a handoff control module 204 in accordance with the principles of the present disclosure as described below in more detail.

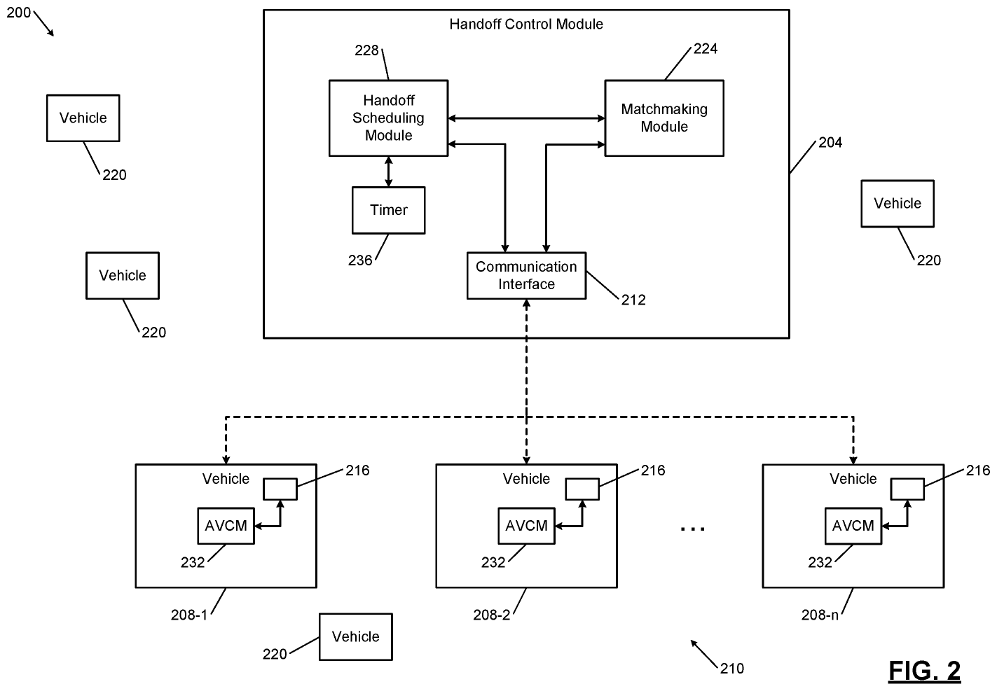

Referring now to FIG. 2, an example vehicle platooning system 200 includes a handoff control module 204 and a plurality of vehicles 208-1, 208-2, . . . , and 208-n, referred to collectively as vehicles 208. The vehicles 208 may correspond to linked vehicles (i.e., vehicles linked in a platoon 210 having a lead vehicle 208-1 and lag vehicles 208-2 . . . 208-n) to form a platoon.

For example, some autonomous and/or semi-autonomous vehicles (each referred to hereinafter as “autonomous” vehicles for simplicity) may be configured to implement a vehicle platooning scheme wherein one vehicle functions as a lead vehicle and one or more other vehicles are follower (“lag”) vehicles. The lead vehicle may be driver-controlled and/or operated in accordance with semi-autonomous control supplemented by driver input. Conversely, the lag vehicles are configured to follow the lead vehicle (e.g., at a predetermined distance, speed, etc.) in accordance with semi-autonomous control. In some examples, the vehicles may be physically connected via a soft hitch connection. Accordingly, drivers of the lag vehicles are able to take advantage of downtime while the driver of the lead vehicle controls and/or partially controls vehicle speed, steering, braking, etc. of the lag vehicles.

For vehicles without autonomous/semi-autonomous capabilities from the factory, a retrofit kit may be installed in these vehicles to control basic functions, such as speed, braking, and steering etc., of these vehicles. Therefore, the vehicles with the retrofit kits can become semi-autonomous and can join a platoon to be partially controlled by the driver of the lead vehicle or to take advantage of the more advanced functionality of the lead vehicle with autonomous or semi-autonomous capabilities.

For example, the vehicles 208 are autonomous vehicles with functionality similar to the vehicle 100 described above in FIG. 1. Each of the vehicles 208 communicates with each other and the handoff control module 204 to implement vehicle platooning (including linking and unlinking of vehicles, and lead vehicle handoffs) as described below in more detail. For example, the handoff control module 204 and each of the vehicles 208 may include respective communication interfaces 212 and 216. For example only, the communication interfaces 212 and 216 may be configured to communicate using one or more protocols including, but not limited to, cellular, WiFi, satellite, and other long and short range communication protocols. The handoff control module 204 and the vehicles 208 may also communicate with unlinked vehicles 220 to add one or more of the unlinked vehicles to the platoon 210.

The handoff control module 204 may include a communication interface 212, a matchmaking module 224, a handoff scheduling module 228, and a timer 236. The handoff control module 204 communicates with the linked vehicles 208 and the unlinked vehicles through the communication interfaces 212 and 216 to implement vehicle platooning (including linking and unlinking of vehicles and lead vehicle handoffs). Although shown separate from the vehicles 208, the structure of the handoff control module 204 may be implemented in any one or more of the vehicles 208 in the platoon 210. In one example, each of the vehicles 208 may include the handoff control module 204 (or similar structure configured to implement the functions of the handoff control module 204) while only the lead vehicle 208-1 at any given time is configured to initiate and coordinate (e.g., schedule) lead vehicle handoffs. In other examples, any of the vehicles 208, including the lag vehicles 208-2 . . . 208-n may be configured to initiate and schedule lead vehicle handoffs. In still other examples, functions of the handoff control module 204 may be implemented remotely from the vehicles 208. For example, the handoff control module 204 may be located within a remote server (e.g., within a cloud computing system).

The handoff control module 204 may communicate with a global positioning system 144 (shown in FIG. 1) of a vehicle (e.g., a lead vehicle) and/or one or more user applications installed on smartphones or tablet computers to receive navigation information, traffic conditions or any information that may be helpful for the handoff control module 204 to implement the platooning scheme. For example, the user applications may be a GPS navigation software application, such as Waze and google maps, which provide navigation and traffic information to the handoff control module 144. Alternatively, the user applications may be ones that allow users to input real-time information about the road conditions and the traffic and share the information with other users. Alternatively, the user applications may be ones that allow the users to send requests to the handoff control module 204 indicating a desire to link or unlink in a platoon such that the handoff control module 204 can implement or change the platooning accordingly.

The matchmaking module 224 is configured to receive requests from vehicles indicating a desire to link in a platoon such as the platoon 210. The requests may be made through a matchmaking module 224 of another handoff control module 204 or a user application installed on a smartphone or a tablet computer. For example, the requests may include current vehicle locations, destinations, and/or one or more additional criteria (e.g., desired route, desired travelling speed, desired downtime or lead vehicle intervals, an indication of autonomous vehicle capabilities, fuel/battery capacity (total and remaining), required refueling/recharging intervals, etc.). If matching destinations (including both final destinations and any intermediate destinations along a common partial route) are identified in two or more of the requests, the handoff control module 204 may communicate information regarding the match to the respective vehicles. The information may include identifiers of the other vehicles having the same final or intermediate destination, contact information, optional additional criteria, etc. In some examples, the requests may be simply communicated directly between vehicles. In other examples, vehicles may periodically “announce” (e.g., broadcast) their destinations and other nearby vehicles receive indications of the destinations.

Drivers of the respective vehicles receive the information about the matching request, destination, etc. and selectively indicate a desire to link with the other vehicle or vehicles in a platoon. For example, the driver may receive the information on a display of a smartphone or other mobile electronic device (e.g., via an app), a vehicle infotainment/navigation system including a display, etc. and selectively press a touchscreen button to initiate the link. In one example, an electronic device such as the smartphone, the tablet computer, the navigation system, etc. implements the handoff control module and the display. For example, identifying information (e.g., a vehicle name, a name of the driver, an icon or image of the vehicle, etc.) of each vehicle having a matching request may appear on the display and the driver may tap the identifying information to initiate the link. The driver may optionally contact the driver of the other vehicle in accordance with contact information provided in the request (using cellular telephone, short wave radio, satellite radio, etc.). If two or more drivers initiate the link, the drivers may manually arrange (i.e., self-drive) the vehicles to form a platoon having a lead vehicle and one or more lag vehicles and/or respective autonomous vehicle control modules (e.g., respective AVCMs 232 of the vehicles 208) may control the vehicles to form the platoon.

As an example, if a first vehicle is traveling on an interstate highway system from a first location to a second location (e.g., from Michigan to California), a second vehicle may be traveling from a third location to the second location (e.g., from Ohio to California). If a common destination such as the second location is identified (e.g., via the matchmaking module 224, direct communication between the first and second vehicles, etc.), the first vehicle may be designated as the lead vehicle (e.g., the lead vehicle 208-1) while the second vehicle is designated as a lag vehicle (e.g., the lag vehicle 208-2). The driver of the lead vehicle 208-1 may self-drive while the lag vehicle 208-2 operates autonomously or semi-autonomously to follow the lead vehicle at a predetermined speed and distance.

Additional vehicles may be added to the platoon 210 along the route in this manner, and vehicles may be removed from the platoon 210 when respective routes diverge. For example, two vehicles may travel together in the platoon 210 until a destination along a common route is reached (e.g., Arizona). However, subsequent destinations for the respective vehicles may diverge. For example, one vehicle may have a final destination of California while the other vehicle has a final destination of New Mexico. Each vehicle may then link with respective other vehicles for the remaining routes. For example, the first vehicle may link with a third vehicle travelling to California while the second vehicle links with a fourth vehicle travelling to New Mexico.

In this manner, the vehicles 208 and 210 are configured (e.g., via the matchmaking module 224 or a user application installed on a smartphone or a tablet computer) to communicate requests to form vehicle platoons and selectively create, join, and/or depart from the platoons in accordance with route information and other travelling criteria as described above.

When a vehicle leaves a platoon to go to a service station, the matchmaking module 224 of the handoff control module 204 may be configured to detect when a next platoon that matches the designation will arrive at or be near the service station. As such, the driver of the vehicle can decide whether or when to join one of the next platoons.

The handoff scheduling module 228 is configured to coordinate lead vehicle handoffs in the linked vehicles 208 in the platoon 210 in accordance with the principles of the present disclosure. The handoff scheduling module 228 is configured to: selectively assign a first vehicle of the linked vehicles 208 in the platoon 210 as a lead vehicle for a first lead vehicle interval and remaining ones of the linked vehicles 208 as lag vehicles; and selectively assign the first vehicle as a lag vehicle and a second vehicle of the plurality of vehicles as the lead vehicle for a second lead vehicle interval before the first lead vehicle interval expires.

The selection of vehicles as the lead vehicles may be based on whether the vehicles are full-autonomous or semi-autonomous. The vehicles in the platoon may include full-autonomous vehicles, semi-autonomous vehicles, and/or vehicles using retrofit kits to become semi-autonomous. The handoff scheduling module 228 may implement a platooning scheme where only the full-autonomous vehicles can be selected as the lead vehicles, while the semi-autonomous vehicle or the vehicles with the retrofit kits are selected as the lag vehicles to take advantage of the full-autonomous functionality of the lead vehicle.

Periodically (e.g., after predetermined intervals), at the request of the driver of the lead vehicle, or when a vehicle leaves or a new vehicle joins the platoon, etc., the sequence of the vehicles 208 in the platoon 210 is rearranged such that one of the lag vehicles 208-2 through 208-n becomes the lead vehicle and the previous lead vehicle 208-1 becomes a lag vehicle. Vehicle sequence rearrangement may be performed via manual driver control and/or autonomously.

In one example, when the lead vehicle 208-1 is initially selected (and/or when the lead vehicle 208-1 is in position at the front of the platoon 210), the timer 236 is initialized and begins to increment. When the timer 236 reaches a determined threshold (i.e., corresponding to a predetermined interval), the handoff scheduling module 228 selects a new lead vehicle provides an indication to the vehicles 208 accordingly. For example, if the rearrangement is to be performed via manual driver control, the indication may simply alert the drivers that a new lead vehicle has been selected and the vehicle sequence should be changed. The respective drivers of the vehicles 208 may then communicate to coordinate rearrangement of the vehicles 208 in the platoon 210. Conversely, if the rearrangement is to be performed autonomously, the indication may alert the drivers that rearrangement of the vehicles 208 will be performed (e.g., at a specific time). In some examples, the handoff scheduling module 228 may request acknowledgement from each of the drivers prior to performing the rearrangement.

The predetermined interval may be negotiated when the platoon 210 is initially performed (and/or when a new vehicle joins the platoon 210). For example, the predetermined interval may be selected in accordance with the initial requests receives by the matchmaking module 224. The predetermined interval may be adjustable. For example, the drivers may communicate while travelling to adjust the interval in accordance with an agreed upon amount. In one example, a driver of the lead vehicle 208-1 or one of the lag vehicles 208-2 through 208-n may request that the interval be shortened or lengthened. If each of the other drivers agrees to the adjustment, the handoff scheduling module 228 may change the predetermined threshold (e.g., in response to a new interval being input by one of the drivers and agreed to by the other drivers). Requests for the new interval, agreement by the other drivers, etc. may be indicated via a touchscreen or other communication interface as described above.

Although as described above each of the vehicles 208 is described as an autonomous vehicle, in some examples one or more of the vehicles 208 may not have autonomous vehicle capabilities and instead may be configured to link to the other vehicles in the platoon 210 via a physical link. In other examples, one or more of the vehicles 208 may use retrofit kits to become semi-autonomous.

As an example, the selection of the vehicles as the lead vehicles and the determination of their lead vehicle intervals may be further based on the fuel levels of the vehicles. Generally, the lag vehicles in the platoon have lower fuel consumption than the lead vehicle due to reduction of wind drag, among others. The vehicles with lower fuel levels may be designated as lag vehicles to leverage improved fuel economy by being lag vehicles. The vehicles with higher fuel levels may take turn to become the lead vehicle and their lead vehicle intervals may be based on the fuel levels of the vehicles to improve fuel economy in the platoon.

In addition, the handoff control module 204 may be configured to send a command to exit the platoon and to recalculate the time when to rejoin the platoon. As an example, when a hazard on the road is identified, there may be a need to temporarily stop platooning to allow the individual vehicles to pass the hazard. The handoff control module 204 may send a command to the vehicles in the platoon to temporarily exit the platoon, recalculate the time that is required for all of the vehicles in the platoon to pass the hazard, and send a command to the vehicles to rejoin the platoon.

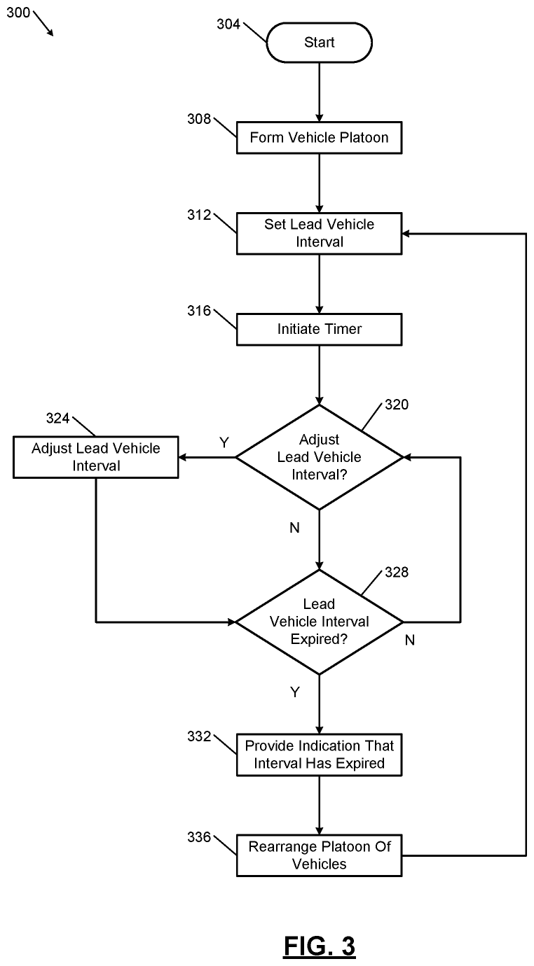

Referring now to FIG. 3, an example method 300 for implementing vehicle platooning begins at step 304. At step 308, the method 300 (e.g., the handoff control module 204, using the matchmaking module 224) forms a platoon of vehicles. For example, the matchmaking module 224 receives one or more requests from respective drivers to link in a platoon as described above and a platoon of linked vehicles including a lead vehicle and one or more lag vehicles is formed accordingly.

At step 312, the method 300 (e.g., the handoff scheduling module 228) determines a lead vehicle interval corresponding to a duration that any vehicle in the platoon is to be designated as the lead vehicle. The lead vehicle interval may be selected in accordance with a default interval, a desired interval indicated in the requests and/or negotiated and input by the drivers, etc. The method 300 may also generate and store (e.g., in the handoff control module 204) a lead vehicle schedule that may be provided to the drivers of the vehicles.

At step 316, the method 300 (e.g., the handoff scheduling module 228) initializes a timer, which begins to increment. At step 320, the method 300 (e.g., the handoff scheduling module 228) determines whether to adjust (e.g., increase or decrease) the selected lead vehicle interval. For example, the method 300 may selectively increase or decrease the lead vehicle interval based on requests received from the drivers of the vehicles in the platoon. If true, the method 300 continues to step 324. If false, the method 300 continues to step 328. At step 324, the method 300 (e.g., the handoff scheduling module 228) adjusts a threshold corresponding to the adjusted lead vehicle interval.

At step 328, the method 300 (e.g., the handoff scheduling module 228) determines whether the lead vehicle interval has expired. If true, the method 300 continues to step 332. If false, the method 300 continues to step 320. At step 332, the method 300 (e.g., the handoff scheduling module 228) provides an indication to the drivers that the lead vehicle interval has expired. The indication may further indicate which vehicle is assigned to be the new lead vehicle, when the sequence of the vehicles in the platoon will be rearranged, etc. At step 336, the new lead vehicle moves into position at the front of the platoon and the outgoing lead vehicle becomes a lag vehicle. For example, the outgoing lead vehicle may move to the end of the platoon. The rearrangement of the vehicles may be performed autonomously or semi-autonomously, via manual driver control, and/or a combination thereof. The method 300 then proceeds to step 312 and determines a new lead vehicle interval.

The vehicle platooning systems and methods according to the present disclosure have the advantages of reducing range anxiety and downtime associated with refueling and/or recharging and increase driver uptime. For fueled, electric, and hybrid electric vehicles, refueling stops and driver downtime increase the duration of long distance travel. For example, although commercial vehicles such as semi-trailer trucks have relatively large fuel tanks (e.g., 100-150 gallons), refueling and driver downtime significantly increase travel time, and batteries of electric and hybrid electric vehicles must be recharged periodically. By linking the vehicles in a platoon, fuel/battery consumption of the lag vehicles is reduced due to reduction of wind drag and other factors associated with being the lead vehicle.

The vehicle platooning systems and methods according to the present disclosure can also reduce driver fatigue by changing the sequence of the vehicles. Periodically (e.g., after predetermined intervals), at the request of the driver of the lead vehicle, or when a vehicle leaves or a new vehicle joins the platoon, etc., the sequence of the vehicles in the platoon is rearranged such that one of the lag vehicles becomes the lead vehicle and the previous lead vehicle becomes a lag vehicle. Vehicle sequence rearrangement may be performed via manual driver control and/or autonomously. In this manner, the lead vehicle alternates amongst all of the vehicles in the platoon and each driver experiences significantly reduced uptime and increased downtime without increasing travel time.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A method of implementing vehicle platooning, the method comprising:
linking, by a handoff control module, a plurality of vehicle to form a platoon;
selectively assigning, by the handoff control module, a first vehicle of the plurality of vehicles as a lead vehicle and remaining ones of the plurality of vehicles as lag vehicles, wherein at least one driving function of the lag vehicles is controlled by the lead vehicle;
determining, by the handoff control module, a first lead vehicle interval for the first vehicle as the lead vehicle; and
in response to the first lead vehicle interval expiring, selectively assigning, by the handoff control module, the first vehicle as a lag vehicle and a second vehicle of the plurality of vehicles as the lead vehicle for a second lead vehicle interval.

2. The method of claim 1, wherein the first lead vehicle interval is determined based on a default interval or a fuel level of the lead vehicle.

3. The method of claim 1, further comprising adjusting the first lead vehicle interval before the first lead vehicle interval expires.

4. The method of claim 3, further comprising receiving by the handoff control module and from the plurality of vehicles, at least one request to adjust the first lead vehicle interval and selectively adjusting, by the handoff control module, the first lead vehicle interval based on the at least one request.

5. The method of claim 4, wherein the at least one request is made by using a cellular phone, a short wave radio, or a satellite radio.

6. The method of claim 1, further comprising transmitting, by the handoff control module, information about the assigned lead and lag vehicles and the first and second lead vehicle intervals to the plurality of vehicles.

7. The method of claim 6, wherein the information includes at least one of a remaining duration of the first lead vehicle interval, an indication that the first lead vehicle interval has expired, and an indication of a next lead vehicle to be assigned in the second lead vehicle interval.

8. The method of claim 1, further comprising disposing the handoff control module in more than one of the plurality of vehicles in the platoon, wherein only the handoff control module in the lead vehicle performs the assigning of the plurality of vehicles as the lead and lag vehicles.

9. The method of claim 1, wherein the handoff control module is integrated in an electronic device selected from a group consisting of a smartphone, a tablet computer, a navigation system, and a remote server.

10. The method of claim 1, further comprising receiving, by the handoff control module and from the plurality of vehicles, at least one desired duration for the first lead vehicle interval and setting, by the handoff control module, the first lead vehicle interval based on the at least one desired duration.

11. The method of claim 1, further comprising selectively repositioning, by an autonomous vehicle control module, a respective one of the plurality of vehicles as the lead vehicle or one of the lag vehicles in response to the information.

12. The method of claim 1, further comprising receiving, by the handoff control module, a request from an unlinked vehicle and re-arranging a sequence of the vehicles in the platoon in response to the request.

13. The method of claim 1, further comprising receiving, by the handoff control module, a request from an unlinked vehicle and adjusting the first lead vehicle interval in response to the request.

14. The method of claim 1, further comprising operating the lag vehicles by a semi-autonomous control module or an autonomous control module of the lag vehicles and by a driver of the lead vehicle.

15. The method of claim 1, wherein the at least one driving function includes at least one of vehicle speed, steering, and braking.

16. The method of claim 1, further comprising initializing a timer when the first lead vehicle is selected.

17. The method of claim 16, wherein when the timer reaches a predetermined threshold, the handoff control module selects the second lead vehicle.

18. The method of claim 1, further comprising displaying the information on a display device in each of the vehicles in the platoon.

19. A system, comprising:
a handoff control module configured to
communicate with a plurality of vehicles linked together in a platoon,
selectively assign, for a first lead vehicle interval, a first vehicle of the plurality of vehicles as a lead vehicle and remaining ones of the plurality of vehicles as lag vehicles, wherein at least one driving function of the lag vehicles is controlled in accordance with the lead vehicle, and
in response to the first lead vehicle interval expiring, selectively assign the first vehicle as a lag vehicle and a second vehicle of the plurality of vehicles as the lead vehicle for a second lead vehicle interval,
wherein the handoff control module comprises a communication interface configured to transmit information about the assigned lead and lag vehicles and the first and second lead vehicle intervals to the plurality of vehicles.

20. The system of claim 19, wherein the handoff control module is disposed in more than one the plurality of vehicles in the platoon and only the handoff control module in the lead vehicle performs the assigning of the plurality of vehicles as the lead and lag vehicles.
